(19) United States
(12) Patent Application Publication
(10) Pub. No.: US 2009/0183842 A1
(43) Pub. Date: Jul. 23, 2009

(54) Systems For Bracing Garage Doors Against Hurricane Force Winds

(76) Inventor: Salvatore Michael DeCola, Viera, FL (US)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(21) Appl. No.: 12/016,424

(22) Filed: Jan. 18, 2008

(51) Int. Cl. E05D 15/00

(52) U.S. Cl. 160/209

(57) ABSTRACT

Equipment and techniques for bracing roll down doors of a building having a plurality of horizontal door panels against severe winds and security against burglary use a horizontal cross bar mounted to the building at connector locations on either side of the door panels. At least one vertical support bar connects to the horizontal cross bar at locations intermediate to the ends of the horizontal cross bar and is secured to the floor using a floor mount. The vertical support bar is connected to door panels at a plurality of points using a rotatable hook.

The equipment can be provided in a kit form for easy installation by a home owner, authorized dealer, or contractor. The apparatus can be quickly and easily installed when a threat of severe wind is anticipated and as easily removed when the threat has passed.

### FIELD OF THE INVENTION

The present invention relates in general to garage door systems, and is particularly directed to a door bracing system made of grooved telescoping column members, that are attachable to a garage door and to the structure of the garage building proper, so as to reinforce and anchor a multi-paneled garage door against high velocity winds and against intrusive using instruments.

### BACKGROUND OF THE INVENTION

A typical multi-panel residential garage door, is comprised of a plurality of panels (usually made of galvanized steel or fiberglass), which are hinged together at hinge joints. The hinge joints are equipped with side wheels or rollers that ride in a pair of guide tracks that extend along opposite sides of the garage door opening. The guide tracks are usually anchored (e.g., bolted) to wall regions of the garage adjacent to the opening and attached via brackets to the ceiling. The door may be opened and closed either by hand or by way of an automated garage door translation device, such as may be mounted to the ceiling and attached to the topmost one of the door panels.

As described in DeCola et al, U.S. Pat. No. 5,620,038, entitled: “System for Bracing Garage Door Against Hurricane Force Winds”, also described in Decola, U.S. Pat. No. 5,964,269, entitled: “System of Telescoping Longitudinally Grooved Door-Stiffening Columns For Bracing Garage Door Against Hurricane Force Winds”, and as described in Decola, U.S. Pat. No. 6,082,431, entitled: “System of Telescoping Longitudinally Grooved Door-Stiffening Columns For Bracing Garage Door Against Hurricane Force Winds,” (the disclosure of each of which is incorporated herein by reference in its entirety), when a multi-panel garage door is exposed to high velocity winds of a violent storm, such as a hurricane, the door panels have a tendency to separate from the guide tracks as a result of continued flexing of the panels and fatigue of the tracks themselves. This repeated flexing causes the side wheels to become detached from the tracks so that the ends of panels become warped, allowing wind to enter the garage and literally rip or ‘peel’ the door away from the garage door opening. Once the garage and adjacent structure has been blown out, the ceiling of the garage and adjacent structure are no longer protected from the extremely high velocity winds of the storm, and it is simply a matter of time before the roof blows off, causing the entire structure to be destroyed.

Follow-up investigation to the widespread damage to residential buildings in south Florida by Hurricane Andrew in 1992 has revealed that had garage doors been reinforced against such separation from the guide tracks, and not blown out, the full force of the hurricane would not have been able to enter many of the destroyed houses. As a result of this investigation, homebuilders in coastal areas of south Florida are required to provide some form of hurricane reinforcement for their garage doors. Recommendations of how to accomplish this have usually involved the installation of (metal or wooden) girts that extend horizontally across each panel. Such girts are intended to stiffen the panels and prevent their oscillatory motion that leads to the destructive separation from the tracks.

Unfortunately, such stiffening panels add considerable weight to the door, requiring adjustments of both the lifting coil spring and of the drive of the automated garage door translation mechanism. Moreover, even with such adjustment, the substantial weight of the girts, for which neither the door nor the automated translation mechanisms were originally designed, leads to further wear and tear of the automatic garage door opener. Yet, even with such stiffeners, the fundamental problem they are intended to solve is not remedied, since they do not prevent torquing of the panels at the point of attachment of the door to the tracks, and do not effectively relieve the wind load placed on the entire garage door opening. The girts are unable to prevent torquing since they extend horizontally - making them parallel to joint lines between panels. Such an orientation provides axes of rotation, about which the panels are torqued when subjected to high velocity winds. The girts provide neither reinforcement nor a separation barrier along the lengths of the tracks, nor do they make the door a wind-loadable door.

Advantageously, the door-bracing system described in the above-reference patents remedies these shortcomings, by means of a door bracing system that contains a plurality of door-stiffening column members that are installed between associated upper mounting brackets above the garage opening and lower mounting brackets affixed to the garage floor. The door bracing system also includes deflection brackets which attach the door panel hinge joints to the column members, so that the entire vertical extent of the garage door is effectively braced against high velocity winds, and thereby prevented from separating along the guide tracks.

### Problems Of The Prior Art

Although the inventions described in U.S. Pat. Nos. 5,620,038; 5,964,269 and 6,082,431 represented a significant advancement over the prior art, each of those patents required that the vertical supports mount to the building housing the garage door above the top of the garage door opening. This made it less convenient to use with roll type garage door without extraordinary efforts. Further, each of those patents require the replacement of hinge pins with longer ones used to connect the panels of the garage door to the vertical supports. Further, there is a lack of flexibility of location in positioning the vertical supports. Further, the top connection of the vertical supports were bolted to the building, which made them difficult to remove once the threat of a hurricane passed. Thus, installation and removal is more difficult.

Further, when a vertical support was placed in between the tracks for the garage door, there was not a positive connection which would protect against both positive and negative air pressure surges.

Finally, the prior art did not allow easy assembly and shipping to a customer in a kit form for do-it-yourself installation.

### BRIEF SUMMARY OF THE INVENTION

The invention is directed to apparatus and techniques for bracing garage doors against hurricane force winds which overcome the problems of the prior art. More specifically, the invention is directed to:

Apparatus for bracing roll down doors of a building having a plurality of substantially horizontal door panels, against severe winds, comprising:
a. a horizontal cross bar mounted to the building at connector locations on either side of the door panels;
b. at least one vertical support bar connected to the horizontal cross bar at a location intermediate to the ends of the horizontal cross bar and secured to the floor using a floor mount;
c. at least one attachment mechanism for connecting the vertical support bar to a panel of the roll down door.

The invention is also directed to the apparatus of paragraph 011 in which the attachment mechanism comprises a rotatable hook.

The invention is also directed to the apparatus of paragraph 012 in which the attachment mechanism comprises a bracket having a channel for receiving the rotatable hook mounted to a door panel.

The invention is also directed to the apparatus of paragraph 013 in which the bracket comprises front and back pieces secured to the door panel through openings in the door panel.

The invention is also directed to the apparatus of paragraph 011 in which the vertical support bar is connected to the horizontal cross bar using a bracket which substantially surrounds the vertical support bar and surrounds the sides and top portion of the horizontal cross bar.

The invention is also directed to the apparatus of paragraph 011 in which the vertical support bar comprises telescoping section, each having a rectangular cross section with T channels extending the length of the vertical support bar.

The invention is also directed to the apparatus of paragraph 016 in which bolts are used to secure a channel slide piece to the vertical support bar with the heads of the bolts inserted into a T channel and in which nuts are screwed on to the bolts and tightened to secure the channel slide piece to the vertical support bar at a selected location.

The invention is also directed to the apparatus of paragraph 017 in which another bolt extends through a portion of the channel slide piece to secure a rotatable hook to the channel slide piece.

The invention is also directed to the apparatus of paragraph 011 in which the horizontal cross bar is mounted to the building at a connector location using at least one L bracket of common design.

The invention is also directed to the apparatus of paragraph 019 in which a single L bracket is bolted to a wood, concrete or steel plate on one face and secures the horizontal cross bar to the other face using a U shaped connector.

The invention is also directed to the apparatus of paragraph 019 in which two L brackets are bolted to a wood, concrete or steel plate on opposite sides of the plate and both L brackets secure the horizontal cross bar to the other faces using a U shaped connector passing through both brackets.

The invention is also directed to the apparatus of paragraph 021 in which the horizontal cross bar is placed between the other faces of said L brackets and is held in place using a U shaped connector passing through both brackets.

The invention is also directed to the apparatus of paragraph 019 in which two L brackets are bolted to a wood, concrete or steel plate on the same side of the plate and in which the horizontal cross bar is placed between the other faces of said L brackets and is held in place using a U shaped connector passing through both brackets.

The invention is also directed to the apparatus of paragraph 019 in which one face of a first L bracket in mounted to a first vertical surface with the other face lying on a horizontal surface and a second L bracket is mounted to a second vertical surface below the horizontal surface with the second face of the second bracket being parallel the other face of the first bracket.

The invention is also directed to the apparatus of paragraph 024 in which horizontal cross bar is mounted between the other face of the first L bracket and the second face of the second L bracket.

The invention is also directed to the apparatus of paragraph 019 in which two L brackets are used, in which the first L bracket is bolted to a wood, concrete or steel plate on one face and secures the horizontal cross bar to the other face using a U shaped connector and a second L bracket is connected to a mounting support for a roll of panels for the garage door horizontally displaced from the first L bracket and in which one end of the first L bracket is attached to the second L bracket using a small bracket.

The invention is also directed to a method for bracing roll down doors of a building having a plurality of substantially horizontal door panels against severe winds, comprising:
a. mounting a horizontal cross bar to the building at connector locations on either side of the door panels;
b. providing at least one vertical support bar connected to the horizontal cross bar at a location intermediate to the ends of the horizontal cross bar and secured to the floor using a floor mount;
c. connecting the vertical support bar to at least one panel of the roll down door using an attachment mechanism.

The invention is also directed to the method of paragraph 027 in which the attachment mechanism comprises a bracket having a channel mounted to a door panel for receiving a rotatable hook.

The invention is also directed to a kit for bracing roll down doors of a building having a plurality of substantially horizontal door panels against severe winds, comprising:
a. a plurality of L brackets;
b. one horizontal cross bar;
c. at least one vertical support bar;
d. a floor mounting bracket; and
e. at least one bracket for substantially surrounding a vertical support bar and for engaging said horizontal cross bar.

The invention is also directed to the kit of paragraph 029 in which the at least one vertical support bar is a telescoping vertical support bar.

The invention is also directed to the kit of paragraph 029 in which at least on vertical support is of substantially rectangular cross section with at least one T channel extending the length of the vertical support bar.

The kit of paragraph 029 further comprising at least one bracket for attaching to a door panel and a rotatable hook for rotating into engagement with said bracket and connecting to the vertical support bar.

### BRIEF DESCRIPTION OF THE DRAWINGS

FIGS. 1A, 1B, and 1C are perspective views of a single, double and triple vertical support for respective, single, double and triple wide garage doors in accordance with one aspect of the invention.

FIG. 2 shows a perspective view of hardware used to attach a telescoping vertical support to the garage door in accordance with one aspect of the invention.

FIG. 3 illustrates a backside piece for attachment to a garage door panel.

FIG. 4 illustrates a front side piece having a U shaped channel for attachment to a garage door panel.

FIG. 5 illustrates a hook piece that rotates to fit into the U shaped channel of FIG. 4 to connect the door to the telescoping vertical support.

FIG. 6 illustrates a channel slide piece that can be adjusted vertically in a T channel track of a vertical support.

FIG. 7 illustrates an alternative technique for connecting the garage door to the vertical support.

FIG. 8 illustrates a first technique for mounting the horizontal cross bar shown in FIG. 1 to the building.

FIG. 9 shows details of the L bracket illustrated in FIG. 8.

FIG. 10 shows a second technique for mounting the horizontal cross bar to the building.

FIG. 11 shows a third technique for mounting the horizontal cross bar to the building.

FIG. 12 shows a fourth technique for mounting the horizontal cross bar to the building.

FIG. 13 shows a fifth technique for mounting the horizontal cross bar to the building.

FIG. 14 shows a sixth technique for mounting the horizontal cross bar to the building.

FIG. 15 shows a seventh technique for mounting the horizontal cross bar to the building.

FIG. 16 is a perspective view of a small bracket used in the mounting arrangement of FIG. 15.

FIG. 17 is a perspective view of an assembly showing how to connect a vertical support to the horizontal cross bar shown in FIGS. 1A, 1B and 1C in accordance with one aspect of the invention.

FIG. 18 is a perspective view of the bracket used in FIG. 17.

FIG. 19 is a detailed view of a preferred version of the bracket shown in FIG. 18.

### DETAILED DESCRIPTION OF THE INVENTION

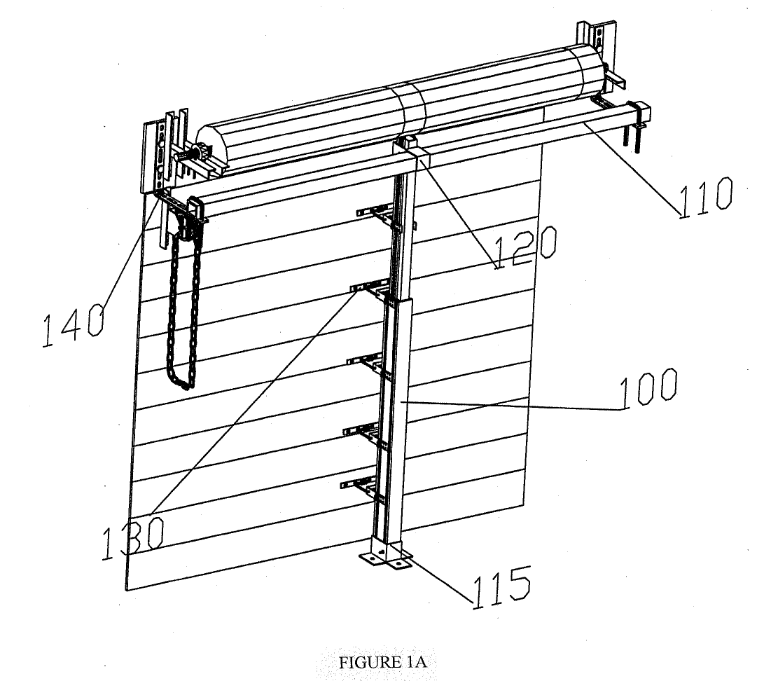

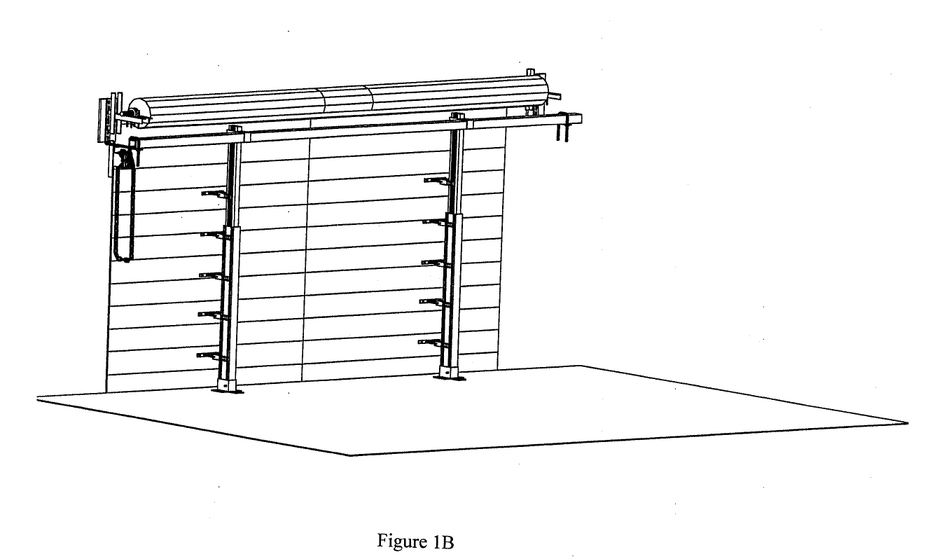

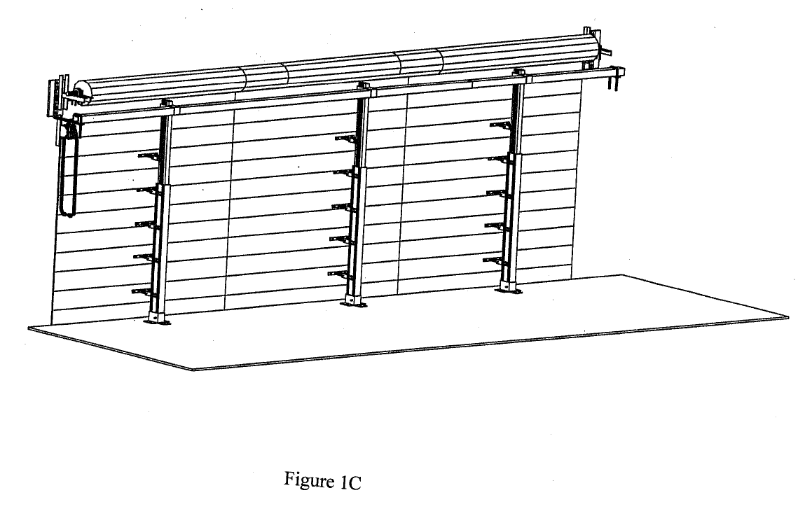

FIG. 1A shows a perspective view of a single vertical support for a singlewide garage door in accordance with one aspect of the invention. The telescoping vertical support 100 is mounted to the floor using a mounting bracket 115 in ways that are shown in the prior art. When the vertical support is removed, the mounting bracket 115 can be removed for normal operation during a time when no hurricane is threatened. The vertical support 100 connects to a cross bar 110 using a bracket 120, described more hereinafter. The vertical support is connected to at least one panel of the garage door using bracket 130, as described more hereinafter. The horizontal cross bar 110 is mounted to the wall of the building using one or more brackets as described more hereinafter.

FIGS. 1B and 1C show perspective views of a double and triple vertical support for double and triple wide garage doors in accordance with one aspect of the invention. In each of these figures, the vertical support 100 is replicated two or three times to accommodate the size of the garage doors.

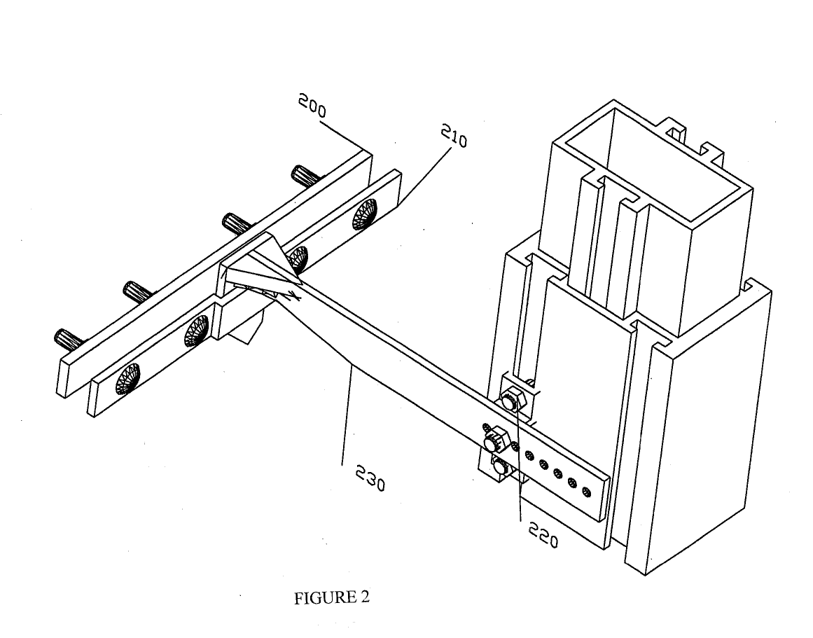

FIG. 2 shows a perspective view of hardware used to attach a telescoping vertical support to the garage door in accordance with one aspect of the invention. Depiction of the thickness of the garage door is not illustrated to permit a view of the mounting of the brackets to the garage door to be visualized more readily. The mounting to the garage door occurs using a rear bracket 200 and a front bracket 210. The two brackets are positioned on opposite sides of a panel thickness for the garage door and are sized so as to permit the panel of the garage door to roll up and be stored in its usual fashion. Bracket 210 has a U channel, described more hereinafter. A channel slide 220 fits into the T channel on the vertical support and can be moved into position and then secured by tightening the nuts associated with the bolt, the bolt head of which rides in the channel. A third bolt, extending from the channel slide is utilized to mount a hook 230, the point of which fits into the U channel of the front bracket 210 of the door mounting brackets.

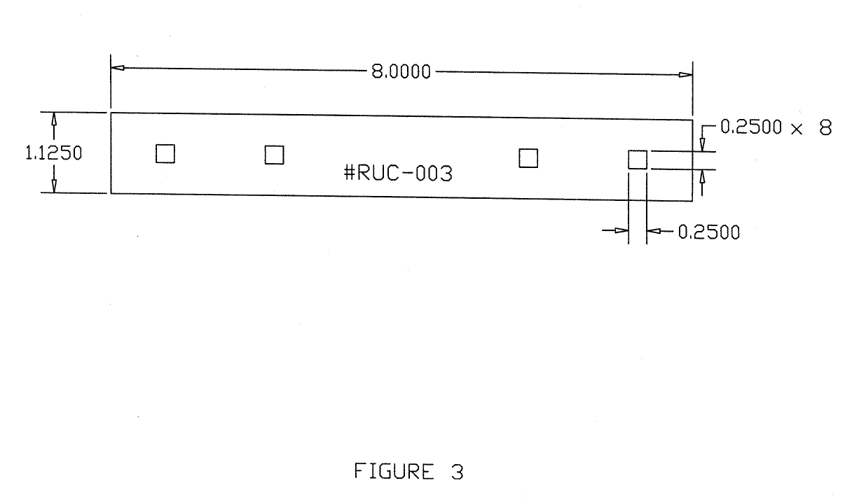

FIG. 3 illustrates a rear bracket piece of a door-mounting bracket for attachment to the garage door panel. The material for the bracket is ⅛ GA steel.

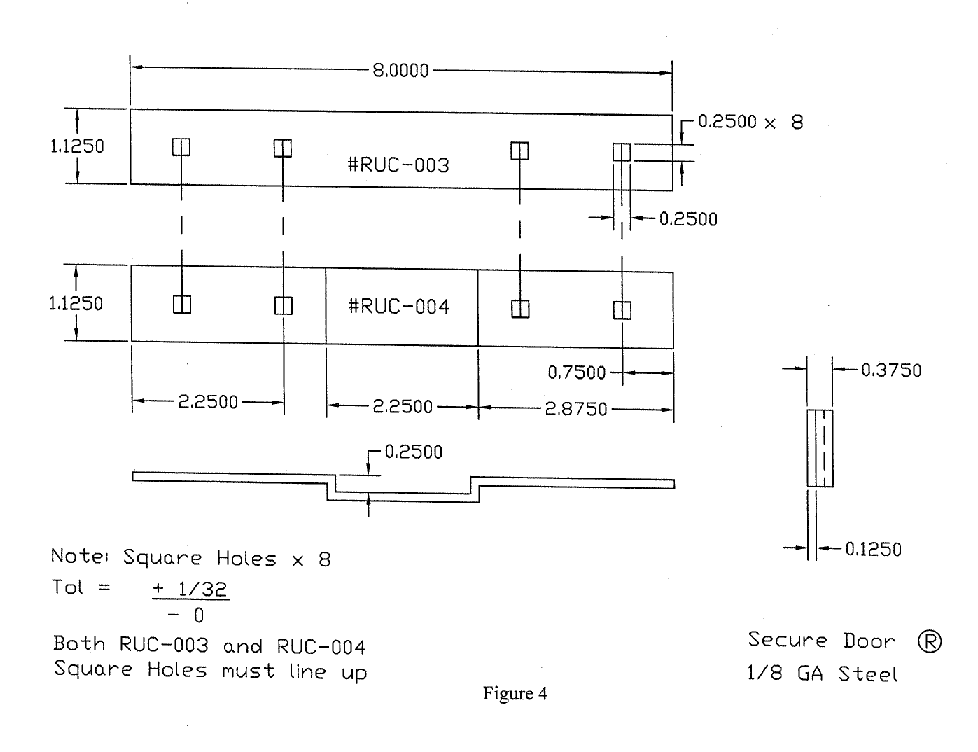

FIG. 4 illustrates the front bracket having a U shaped channel for attachment to the garage door.

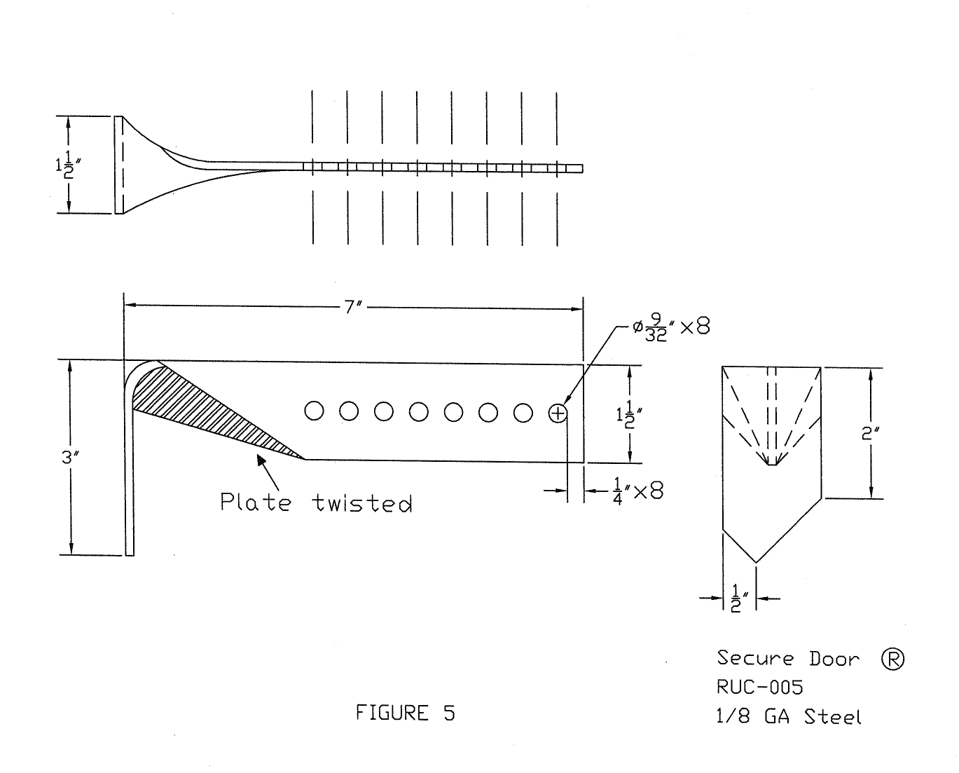

FIG. 5 illustrates a hook piece that rotates to fit into the U shaped channel of FIG. 4 to connect the door mounting brackets to the telescoping vertical support.

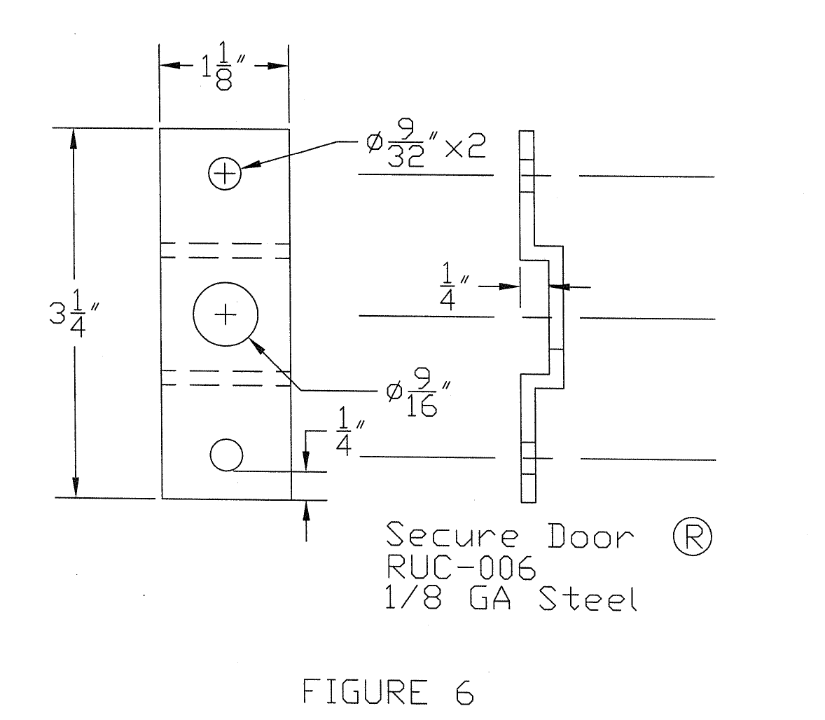

FIG. 6 illustrates the details of the construction of a channel slide piece that can be adjusted vertically in a track of a vertical support.

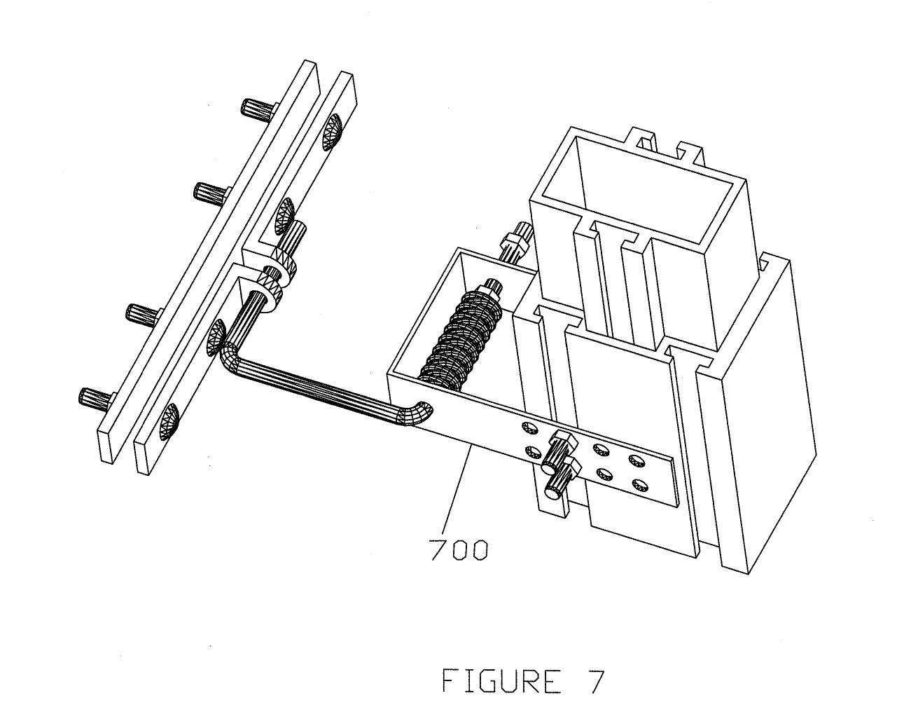

FIG. 7 illustrates an alternative technique for connecting the garage door to the vertical support. In this case, a bracket 700 is mounted to the vertical slide using the bolt heads to guide the bracket positioning of the bracket in the T channel of the vertical support. The bracket 700 is configured to receive and mount a spring-loaded J channel which can be inserted into the holes of the front side door mounting brackets of slightly modified construction shown in FIG. 7. To remove the J channel, the channel is pulled to the left until it clears the holes and then it can be released to be held in place by the spring for use when it is installed at a later time. The spring keeps the J channel out of the way when the vertical supports are stored when no hurricane threat is present.

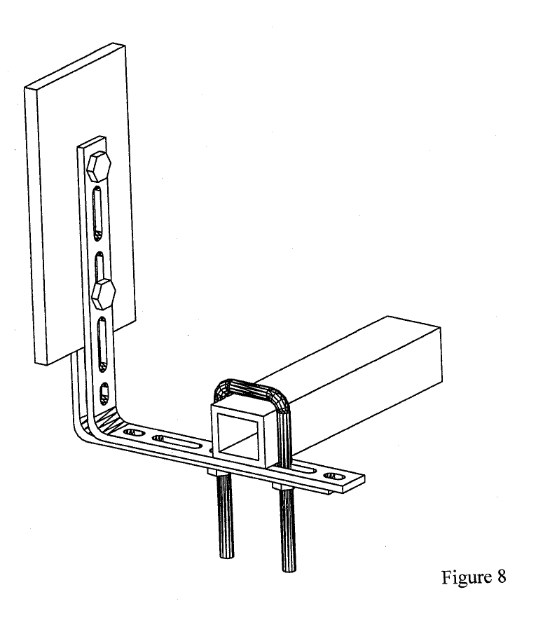

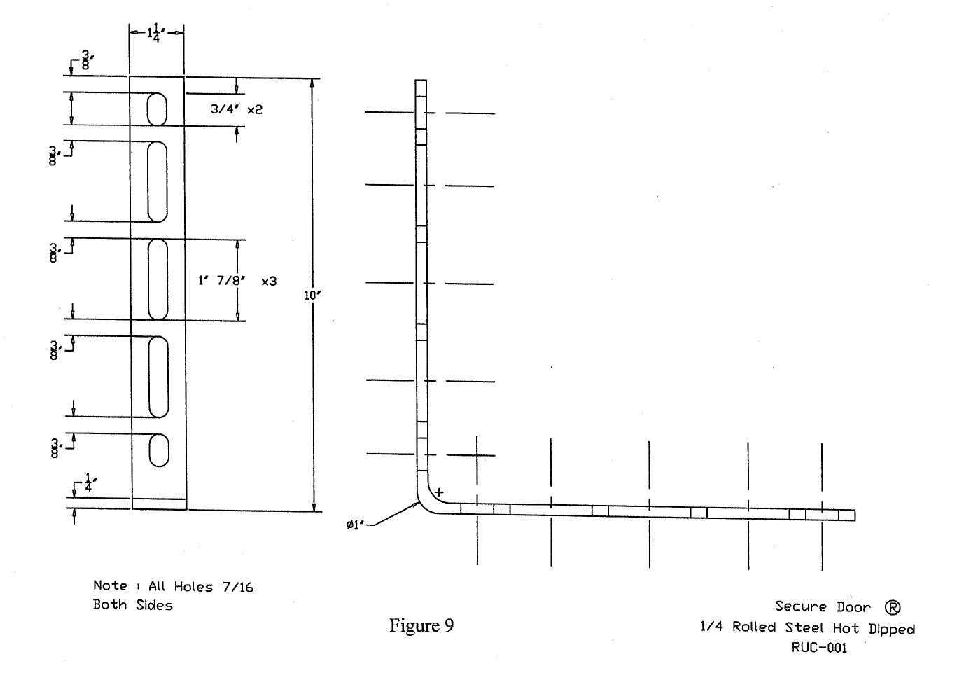

FIG. 8 illustrates a first technique for mounting the horizontal cross bar shown in FIG. 1A to the building. As shown, the horizontal cross bar is held in place by a U channel inserted through the lower portion of an L bracket, the vertical portion of which is mounted to a wood, concrete or steel plate securely fastened to the building. The details of the L bracket illustrated with FIG. 8 are shown in FIG. 9.

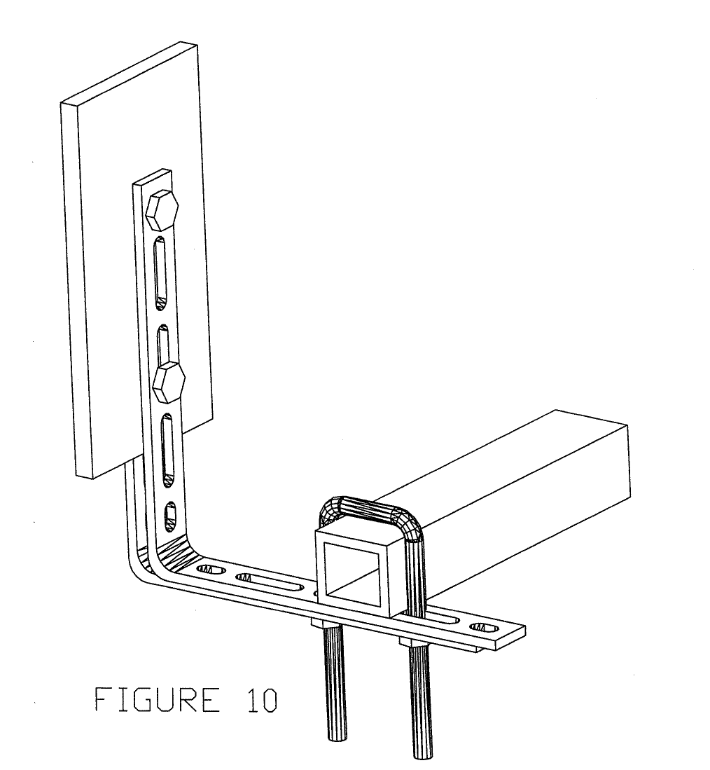

FIG. 10 shows a second technique for mounting the horizontal cross bar to the building. This technique uses two L brackets, one on either side of a plate to provide additional strength.

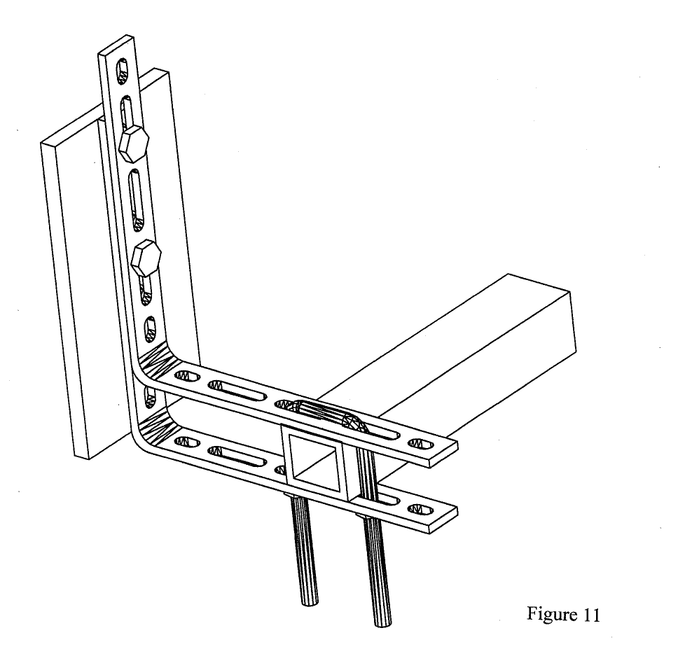

FIG. 11 shows a third technique for mounting the horizontal cross bar to the building. This technique also utilizes two L brackets with the bottom piece of each L bracket being on opposite sides of the channel cross bar.

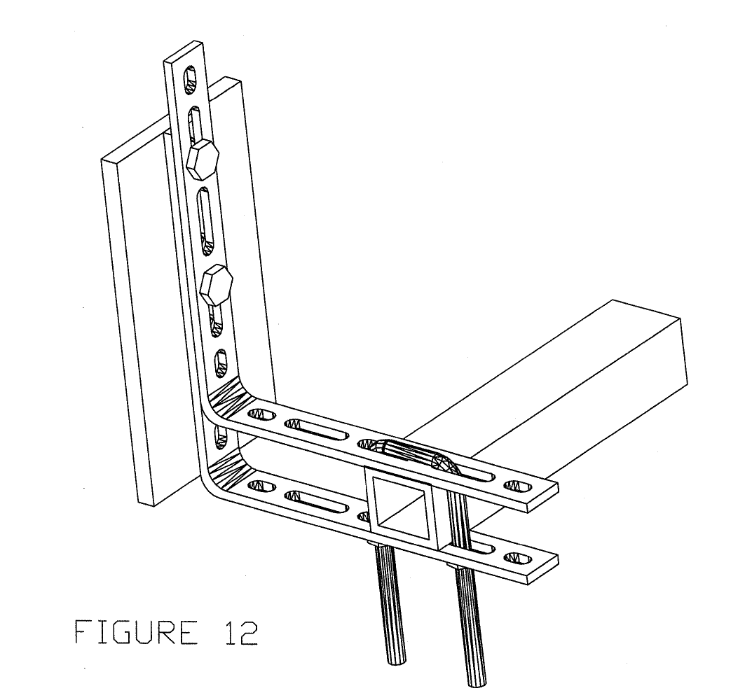

FIG. 12 shows a forth technique for mounting the horizontal cross bar to the building. This figure is like FIG. 11, except that both L brackets are mounted on the same side of the mounting plate.

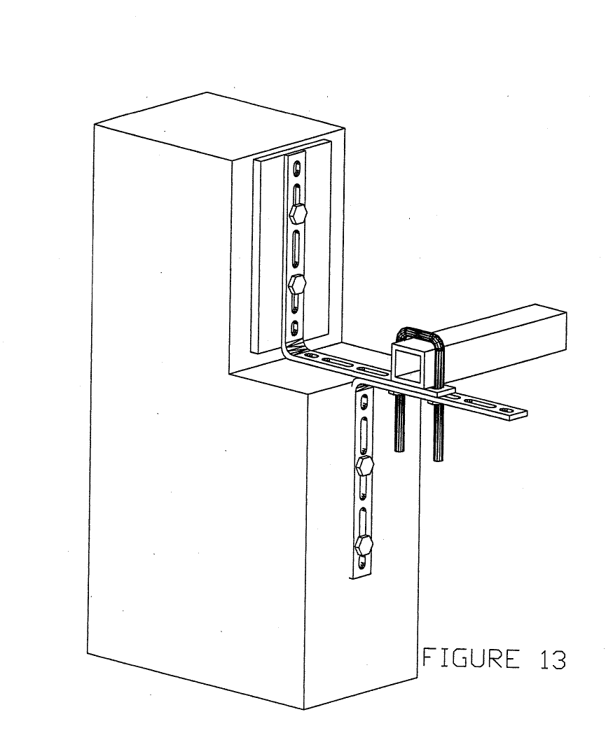

FIG. 13 shows a fifth technique for mounting the horizontal cross bar to the building. In this case, one L bracket is utilized to mount to a plate against one portion of the building and a second L bracket, mounted below, accommodates the step nature of the building construction at the point of attachment.

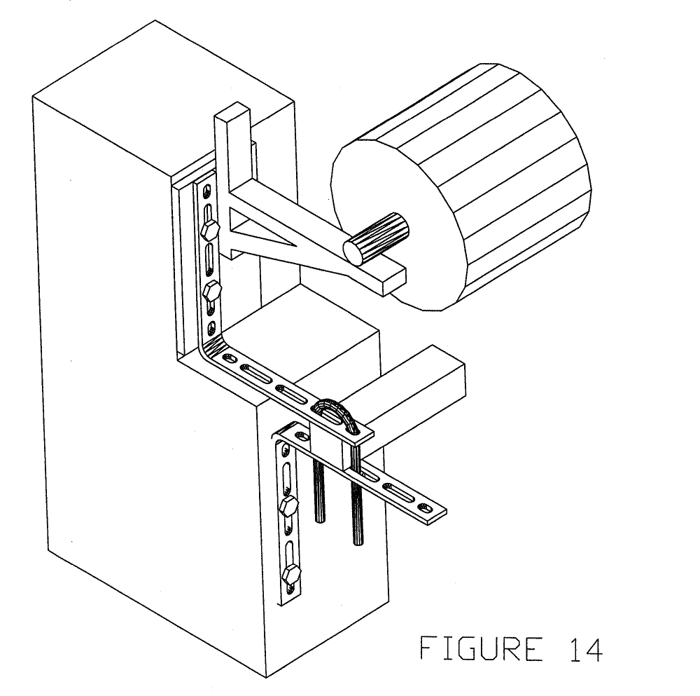

FIG. 14 shows a sixth technique for mounting the horizontal cross bar to the building. Again, there is a step displacement which can be utilized effectively by mounting two L brackets, one above and one below the cross bar position.

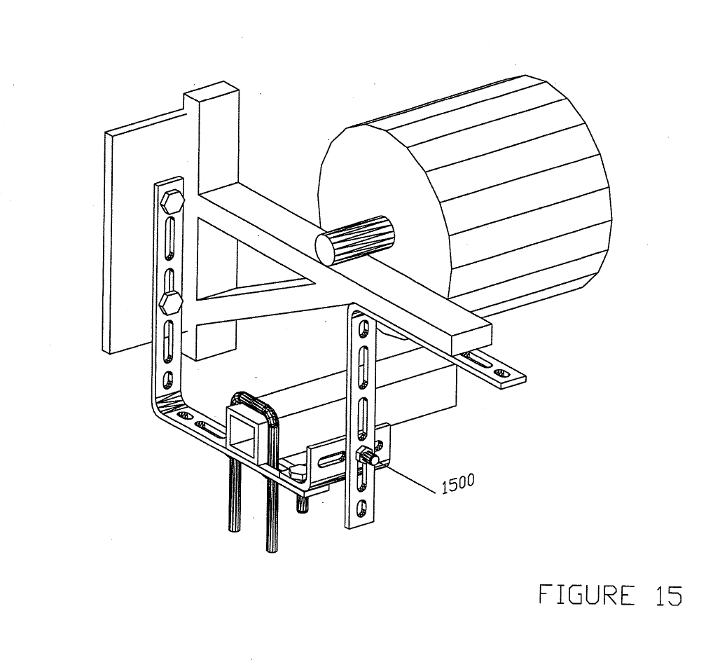

FIG. 15 shows a seventh technique for mounting the horizontal cross bar to the building. In this case, this technique is similar to that shown in FIG. 8 except that a small bracket 1500, is utilized to displace an L bracket so that it can attach underneath the bracing to which the roll for the garage door panels is mounted. This allows yet added strength.

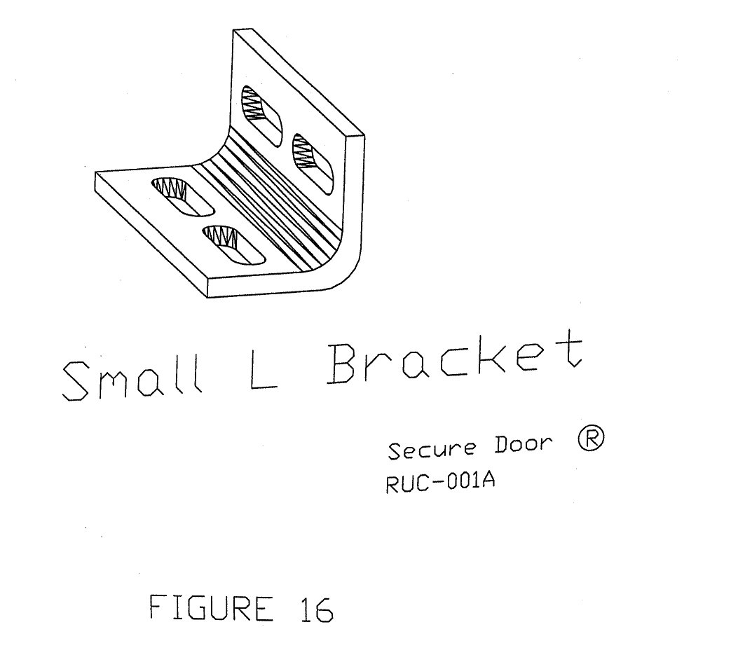

FIG. 16 is a perspective view of a small bracket used in the mounting arrangement of FIG. 15. Each of the techniques for mounting the horizontal cross bar to the building shown in FIGS. 8-15, utilize the same L bracket. That is, the construction of the L bracket is such as to accommodate a variety of configurations and mountings. This allows a single piece to have multiple uses and to reduce the number of pieces that might need to be stored or fabricated for an installation by homeowner in a do-it-yourself installation.

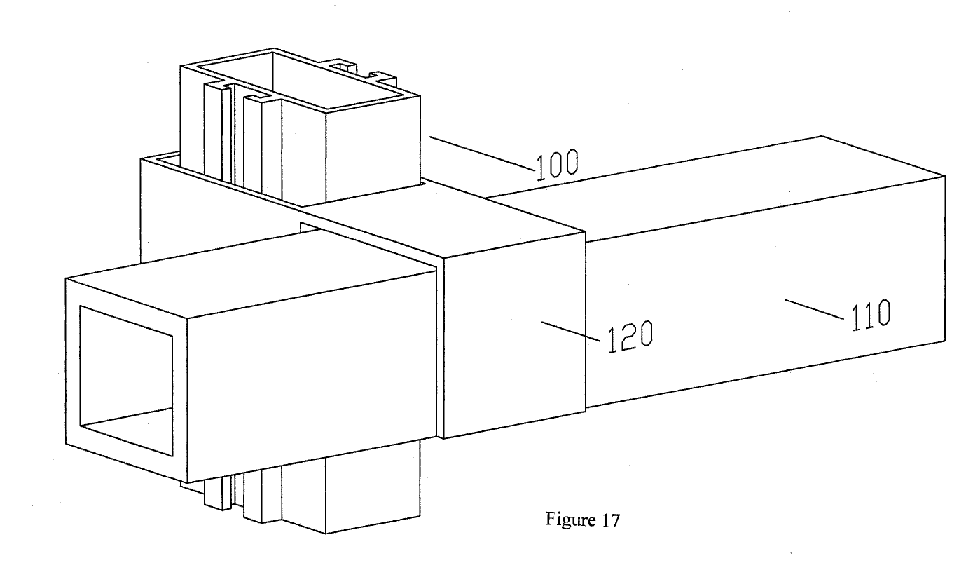

FIG. 17 is a perspective view of an assembly showing how to connect a vertical support to the horizontal crossbar shown in FIGS. 1A, 1B and 1C.

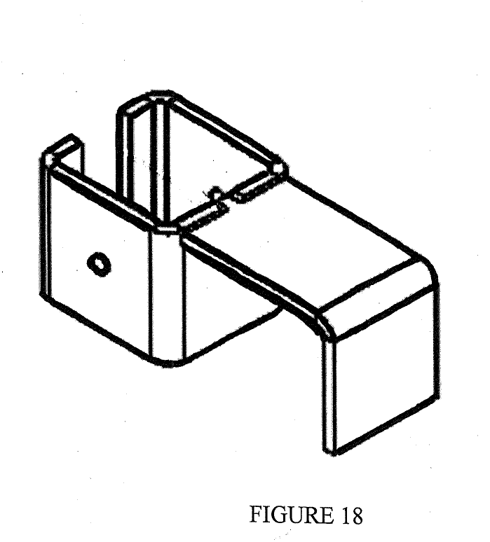

FIG. 18 provides a perspective view of the bracket used in the attachment of FIG. 17.

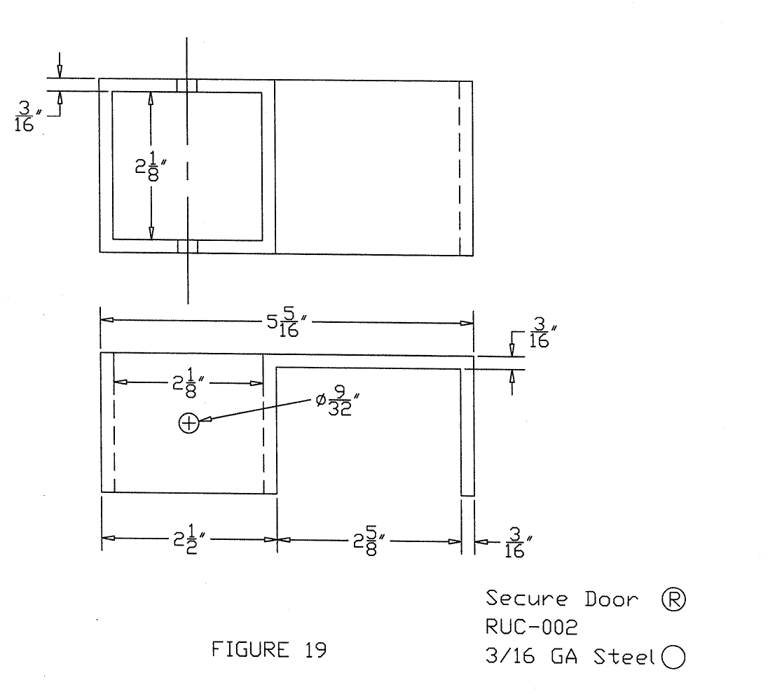

FIG. 19 provides a detailed view of a preferred version of the bracket shown in FIG. 17.

Returning to FIG. 17, one can see that the bracket and the mounting bolt locations are configured so that the head of the mounting bolts can slide in the T channels of the vertical support, allowing it to be adjustable up and down the vertical support.

Turning again to FIG. 1A, the vertical cross bar (s) the horizontal cross bar, the L brackets for mounting, the door mounting brackets 130 can be conveniently packed and shipped as a kit for easy installation by a homeowner, authorized dealer or contractor. Once installed, the vertical supports can be easily removed by disconnecting the hook from each of the door panel mounting brackets and by sliding the vertical brace 100 on crossbar 110 to either side of the horizontal bar to be secured to the side wall or by lifting the bracket 120 attached to the vertical support 100 so that the top of the bracket 120 clears the horizontal cross bar so that it can be removed and stored. The floor bracket is fastened to the vertical brace and moves with the vertical brace. Push rods can be used to slide into 2 predrilled holes thru a plate fastened in the floor. This plate will remain in the floor and can be driven over etc. Thus, with the L brackets and the cross bar in place, a homeowner can quickly and easily slide the rods into the floor bracket into previously drilled holes, connect or slide the vertical support(s) to or on the horizontal cross bar using bracket 120, adjust the channel slides to the corresponding heights of the U channels of the door mounting brackets and have a positive connection between the door panels and the vertical support bar that will protect the door against both positive and negative pressure. The sizing of the door mounting brackets are such that they can be accommodated in the roll up of the door panels when the door is open.

There has thus been described an extremely effective and easy to install method of protecting garage doors during a threat of a hurricane or used for security when installed to prevent the rollup door from opening. The installation as described can be done quickly, on short notice once a wind storm is threatened. Once the threat is past it can be removed and stored using a minimum of space.

The arrangement described provides easy installation even by a do-it-yourself homeowner. The arrangement described also allows itself to be shipped conveniently as a kit from a distribution point to the homeowner.

While various embodiments of the present invention have been illustrated herein in detail, it should be apparent that modifications and adaptations to those embodiments may occur to those skilled in the art without departing from the scope of the present invention as set forth in the following claims.

1. Apparatus for bracing roll down doors of a building having a plurality of substantially horizontal door panels, comprising:
a. a horizontal cross bar mounted to the building at connector locations on either side of the door panels;
b. at least one vertical support bar connected to the horizontal cross bar at a location intermediate to the ends of the horizontal cross bar and secured to the floor using a floor mount;
c. at least one attachment mechanism for connecting the vertical support bar to a panel of the roll down door.

2. The apparatus of claim 1 in which the attachment mechanism comprises a rotatable hook.

3. The apparatus of claim 2 in which the attachment mechanism comprises a bracket having a channel for receiving the rotatable hook mounted to a door panel.

4. The apparatus of claim 3 in which the bracket comprises front and back pieces secured to the door panel through openings in the door panel.

5. The apparatus of claim 1 in which the vertical support bar is connected to the horizontal cross bar using a bracket which substantially surrounds the vertical support bar and surrounds the sides and top portion of the horizontal cross bar.

6. The apparatus of claim 1 in which the vertical support bar comprises telescoping section, each having a rectangular cross section with T channels extending the length of the vertical support bar.

7. The apparatus of claim 6 in which bolts are used to secure a channel slide piece to the vertical support bar with the heads of the bolts inserted into a T channel and in which nuts are screwed on to the bolts and tightened to secure the channel slide piece to the vertical support bar at a selected location.

8. The apparatus of claim 7 in which another bolt extends through a portion of the channel slide piece to secure a rotatable hook to the channel slide piece.

9. The apparatus of claim 1 in which the horizontal cross bar is mounted to the building at a connector location using at least one L bracket of common design.

10. The apparatus of claim 9 in which a single L bracket is bolted to a wood, concrete or steel plate on one face and secures the horizontal cross bar to the other face using a U shaped connector.

11. The apparatus of claim 9 in which two L brackets are bolted to a wood, concrete or steel plate on opposite sides of the plate and both L brackets secure the horizontal cross bar to the other faces using a U shaped connector passing through both brackets.

12. The apparatus of claim 11 in which the horizontal cross bar is placed between the other faces of said L brackets and is held in place using a U shaped connector passing through both brackets.

13. The apparatus of claim 9 in which two L brackets are bolted to a wood, concrete or steel plate on the same side of the plate and in which the horizontal cross bar is placed between the other faces of said L brackets and is held in place using a U shaped connector passing through both brackets.

14. The apparatus of claim 9 in which one face of a first L bracket in mounted to a first vertical surface with the other face lying on a horizontal surface and a second L bracket is mounted to a second vertical surface below the horizontal surface with the second face of the second bracket being parallel the other face of the first bracket.

15. The apparatus of claim 14 in which horizontal cross bar is mounted between the other face of the first L bracket and the second face of the second L bracket.

16. The apparatus of claim 9 in which two L brackets are used, in which the first L bracket is bolted to a wood, concrete or steel plate on one face and secures the horizontal cross bar to the other face using a U shaped connector and a second L bracket is connected to a mounting support for a roll of panels for the garage door horizontally displaced from the first L bracket and in which one end of the first L bracket is attached to the second L bracket using a small bracket.

17. A method for bracing roll down doors of a building having a plurality of substantially horizontal door panels against severe winds, comprising:
a. mounting a horizontal cross bar to the building at connector locations on either side of the door panels;
b. providing at least one vertical support bar connected to the horizontal cross bar at a location intermediate to the ends of the horizontal cross bar and secured to the floor using a floor mount;
c. connecting the vertical support bar to at least one panel of the roll down door using an attachment mechanism.

18. The method of claim 17 in which the attachment mechanism comprises a bracket having a channel mounted to a door panel for receiving a rotatable hook.

19. A kit for bracing roll down doors of a building having a plurality of substantially horizontal door panels against severe winds, comprising:
a. a plurality of L brackets;
b. one horizontal cross bar;
c. at least one vertical support bar;
d. a floor mounting bracket; and
e. at least one bracket for substantially surrounding a vertical support bar and for engaging said horizontal cross bar.

20. The kit of claim 19 in which the at least one vertical support bar is a telescoping vertical support bar.

21. The kit of claim 19 in which the at least on vertical support is of substantially rectangular cross section with at least one T channel extending the length of the vertical support bar.

22. The kit of claim 19 further comprising at least one bracket for attaching to a door panel and a rotatable hook for rotating into engagement with said bracket and connecting to the vertical support bar.
